(19) United States
(12) Patent Application Publication
(10) Pub. No.: US 2019/0251874 A1
(43) Pub. Date: Aug. 15, 2019

(54) Sign Clip

(71) Applicant: Paul Leroy Patterson, Denver, CO (US)

(72) Inventor: Paul Leroy Patterson, Denver, CO (US)

(21) Appl. No.: 16/274,077

(22) Filed: Feb. 12, 2019

Related U.S. Application Data
(60) Provisional application No. 62/629,816, filed on Feb. 13, 2018.

(51) Int. Cl. G09F 7/18; F16M 13/02

(52) U.S. Cl. CPC G09F 7/18; F16B 2/22; F16M 13/02

(57) ABSTRACT

A sign clip for attaching a sign to a post may include a front piece and two side pieces forming a square with an open side. The side pieces may each have a hook piece on the back to prevent the clip from moving forward. Compressible bumpers on the inside of the sign clip may either be pressed up against the post by the spring force of the side pieces, or may slip inside holes in the sign post. Clip pieces extending down from the front piece may hold a sign to the post. The sign clip may enable convenient attachment of the sign to the post without the use of tape, string, glue, ties, or other materials that may be difficult to remove.

### CROSS-REFERENCE TO RELATED APPLICATION

This application claims priority to, and the benefit of, U.S. Provisional Application Ser. No. 62/629,816 filed on Feb. 13, 2018, entitled SIGN CLIP. The entire contents of the foregoing application are hereby incorporated by reference for all purposes.

### BACKGROUND

The following relates generally to attaching a sign to a post, and more specifically to attaching a sign to a square post using a clip wrapping around the sign post.

People may communicate messages by printing them on signs and placing them in areas that may be visible to the target of the communication These signs may be used to communicate marketing information, political preferences, event information, or virtually any other type of information. In some cases, signs may be attached to a means for fixing the sign to a specific location. For example, a sign may be attached to a sign post, which is fixed to the ground.

However, it may not be practical, convenient, or cost effective to provide a new sign post for each sign. For example, a sign may be attached to a sign post, which is fixed to the ground.

### SUMMARY

A sign clip for attaching a sign to a post may include a front piece and two side pieces forming a square with an open side. The side pieces may each have a hook piece on the back to prevent the clip from moving forward. Compressible bumpers on the inside of the sign clip may either be pressed up against the post by the spring force of the side pieces, or may slip inside holes in the sign post. Clip pieces extending down from the front piece may hold a sign to the post. The sign clip may enable convenient attachment of the sign to the post without the use of tape, string, glue, ties, or other materials that may be difficult to remove.

An apparatus for attaching a sign to a square post using a clip wrapping around the sign post is described. The apparatus may include a front piece comprising a front rectangular plane and a front depth, wherein the front rectangular plane comprises a front height and a front width, two side pieces connected to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side, one or more hook pieces, wherein each of the hook pieces is connected to one of the two side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square, one or more bumpers located on an interior side of the front piece or one of the two side pieces, wherein the interior side comprises a side of the front piece or one of the two side pieces on the interior of the open square, and one or more clip pieces connected to the front piece.

A system for attaching a sign to a square post using a clip wrapping around the sign post is described. The system may include a front piece comprising a front rectangular plane and a front depth, wherein the front rectangular plane comprises a front height and a front width, two side pieces connected to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side, one or more hook pieces, wherein each of the hook pieces is connected to one of the two side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square, one or more bumpers located on an interior side of the front piece or one of the two side pieces, wherein the interior side comprises a side of the front piece or one of the two side pieces on the interior of the open square, and one or more clip pieces connected to the front piece.

A method of manufacturing an apparatus for attaching a sign to a square post using a clip wrapping around the sign post is described. The method may include providing a front piece comprising a front rectangular plane and a front depth, wherein the front rectangular plane comprises a front height and a front width, providing two side pieces connected to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side, providing one or more hook pieces, wherein each of the hook pieces is connected to one of the two side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square, providing one or more bumpers located on an interior side of the front piece or one of the two side pieces, wherein the interior side comprises a side of the front piece or one of the two side pieces on the interior of the open square, and providing one or more clip pieces connected to the front piece.

A method of using an apparatus for attaching a sign to a square post using a clip wrapping around the sign post is described. The method may include attaching the sign to the sign post using a front piece comprising a front rectangular plane and a front depth, wherein the front rectangular plane comprises a front height and a front width, using two side pieces connected to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side, using one or more hook pieces to secure the apparatus, wherein each of the hook pieces is connected to one of the two side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square, using one or more bumpers located on an interior side of the front piece or one of the two side pieces, wherein the interior side comprises a side of the front piece or one of the two side pieces on the interior of the open square, and using one or more clip pieces connected to the front piece.

In some examples of the apparatus, system, and method described above, the front piece, the two side pieces, and the one or more hook pieces comprise a rigid material and the bumpers comprise a compressible material having a compressibility greater than the rigid material. In some examples of the apparatus, system, and method described above, the front piece, the two side pieces, and the one or more hook pieces comprise a plastic, wood, metal, or any combination thereof. In some examples of the apparatus, system, and method described above, the one or more bumpers comprise rubber bumpers, elastomer bumpers, or any combination thereof.

In some examples of the apparatus, system, and method described above, the one or more bumpers comprise a circular shape. In some examples of the apparatus, system, and method described above, the one or more clip pieces extend a first length in the direction of the front rectangular plane and a second length in the direction of the front depth toward the interior of the square. In some examples of the apparatus, system, and method described above, each of the one or more clip pieces comprise a spring component. In some examples of the apparatus, system, and method described above, the front piece, the two side pieces, the one or more hook pieces, and the clip pieces comprise a seamless structure from a single material.

### BRIEF DESCRIPTION OF THE DRAWINGS

FIG. 1 shows an example of a sign post with a sign clip in accordance with aspects of the present disclosure.

FIG. 2 shows an example of an angled perspective view of a sign clip in accordance with aspects of the present disclosure.

FIG. 3 shows an example of a top view of a sign clip in accordance with aspects of the present disclosure.

FIG. 4 shows an example of a top view of a sign clip with a short side piece in accordance with aspects of the present disclosure.

FIG. 5 shows an example of a front view of a sign clip in accordance with aspects of the present disclosure.

FIG. 6 shows an example of a side view of a sign clip in accordance with aspects of the present disclosure.

FIG. 7 shows an example of manufacturing a sign clip in accordance with aspects of the present disclosure.

FIG. 8 shows an example of attaching a sign to a post in accordance with aspects of the present disclosure.

### DETAILED DESCRIPTION

The description set forth below is intended as a description of various embodiments and is not intended to represent the only configurations in which the subject matter of this disclosure can be practiced. It will be clear and apparent that the subject matter of this disclosure is not limited to the specific details set forth herein. In some instances, structures and components are shown in block diagram form in order to avoid obscuring the concepts of the subject matter of this disclosure.

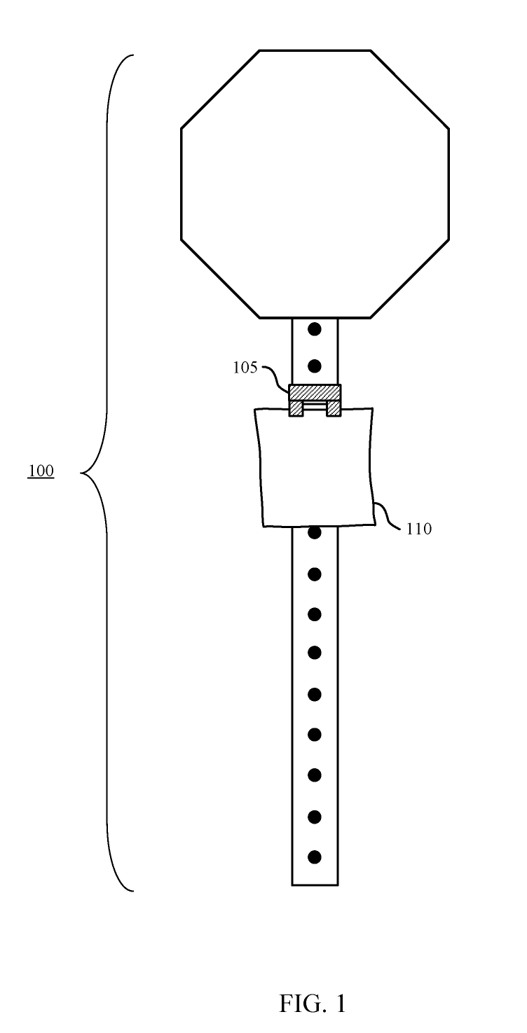

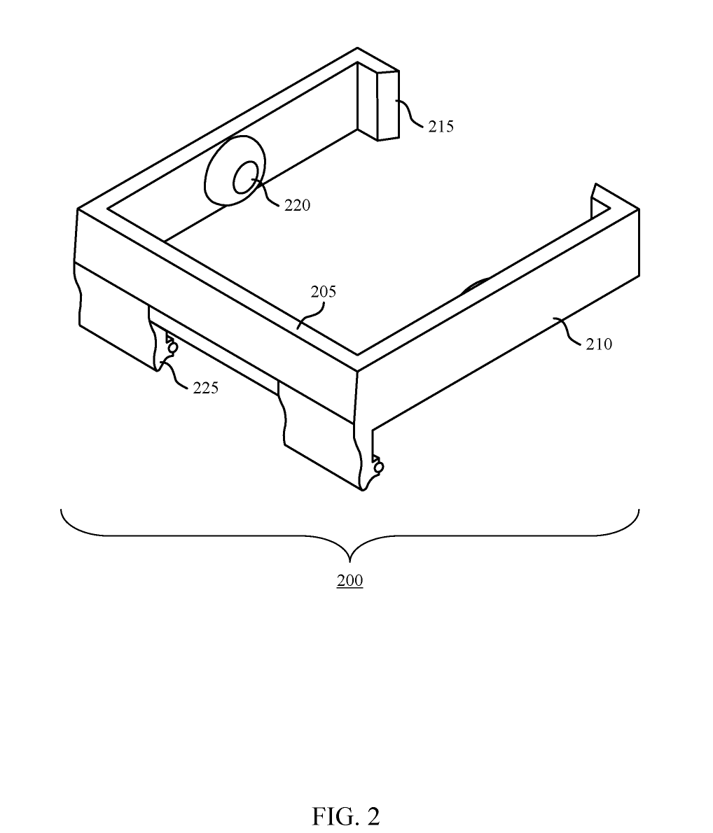

FIG. 1 shows an example of a sign post 100 with a sign clip 105 in accordance with aspects of the present disclosure. The example shown includes sign post 100, sign clip 105, and sign 110. Sign clip 105 may be an example of, or include aspects of, the corresponding element described with reference to FIGS. 2, 3, 4, 5, and 6.

A sign clip 105 may be used to attach a sign 110 or other object to a square pole such as a street sign 110. The sign clip 105 may be in the shape of a square with at least a portion of one side open. That is, a front piece may be attached to a perpendicular side piece at each end. One or more clip pieces may extend vertically from the front piece, and may then extend a short distance in the direction of the interior of the square. At least one or the side pieces may wrap around a post, and a sign 110 or another flat object may be inserted between the post and the clip pieces. Thus, the sign clip 105 may hold the sign 110 in place without rope, ties, tape, string, duct tape, zip ties, or glue. This may also enable the sign 110 to be removed easily without damaging the sign 110, or leaving behind parts of the sign 110, tie, tape, string or glue.

The sign clip 105 may be sized such that it is just large enough to wrap around a sign post 100. For example, a sign clip may be sized to fit around a 2″ or 2.5″ inch sign post 100, with the interior of the sign clip 105 just larger than the dimension of the sign post 100 and the exterior of the sign clip 105 a square with sides equal to the interior dimension plus the width of the side pieces.

The front and side pieces may be made of a rigid material such as plastic, wood or metal. Each piece may include a hook piece, i.e. a short extension, extending partially along the open side of the square and configured to prevent the sign clip 105 from moving toward the front of the sign clip 105 or falling off the sign 110. However, the material used to form the sign clip 105 may be sufficiently flexible to allow the side pieces to be placed around the supporting structure (i.e., the pole).

One or more bumpers may be located on the inner surface of the front and pieces. The front and side pieces of the sign clip 105 may compress the bumpers against the sign post 100 to produce friction sufficient to hold the sign clip 105 in place on a supporting structure. The bumpers may be made of a compressible material such as rubber or an artificial elastomer. In some cases, the supporting structure such as sign post 100 may have one or more holes in the sides of the post, and the bumpers may have a shape and position such that they fit within the holes. For example, a sign post 100 may have circular holes on the sides of the post and the bumpers may have a circular shape. If the bumpers fit within holes of the sign post, the sign clip may be held in place by a force exerted by the interior of the holes (i.e., as opposed to friction caused by compressing the bumpers against the sign post 100). In some cases the clip pieces include springs capable of closing the clip pieces over an edge of the sign 110.

In some examples, the front piece, the two side pieces, and the one or more hook pieces comprise a rigid material and the bumpers comprise a compressible material having a compressibility greater than the rigid material; the front piece, the two side pieces, and the one or more hook pieces comprise a plastic, wood, metal, or any combination thereof; and the front piece, the two side pieces, the one or more hook pieces, and the clip pieces comprise a seamless structure from a single material or any combination thereof.

FIG. 2 shows an example of an angled perspective view of a sign clip 200 in accordance with aspects of the present disclosure. The example shown includes sign clip 200, which may be an example of, or include aspects of, the corresponding element described with reference to FIGS. 1, 3, 4, 5, and 6.

In some examples, the front piece 205, the two side pieces 210, and the one or more hook pieces 215 comprise a rigid material and the bumpers 220 comprise a compressible material having a compressibility greater than the rigid material; the front piece 205, the two side pieces 210, and the one or more hook pieces 215 may comprise a plastic, wood, metal, or any combination thereof; and the front piece 205, the two side pieces 210, the one or more hook pieces 215, and the clip pieces, or any combination thereof, comprise a seamless structure from a single material.

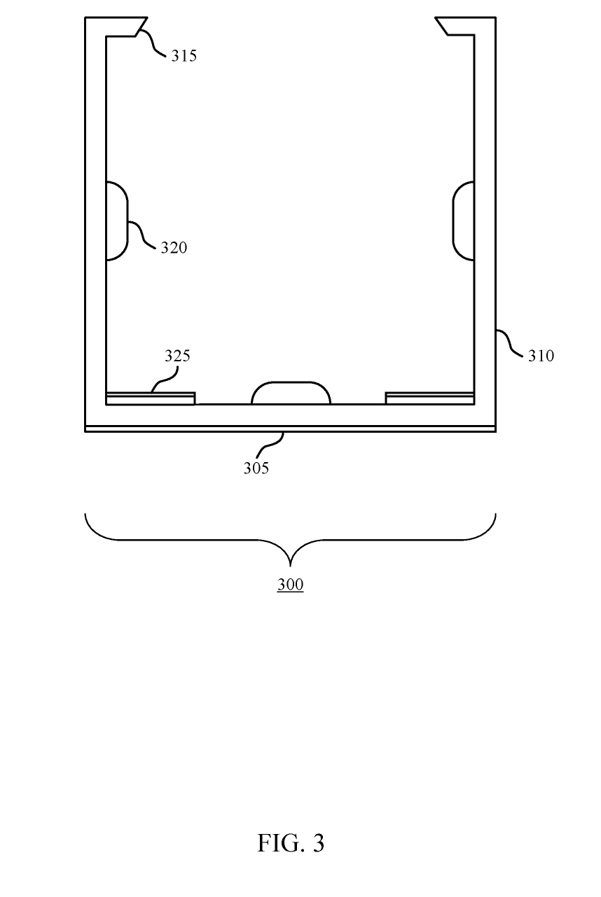

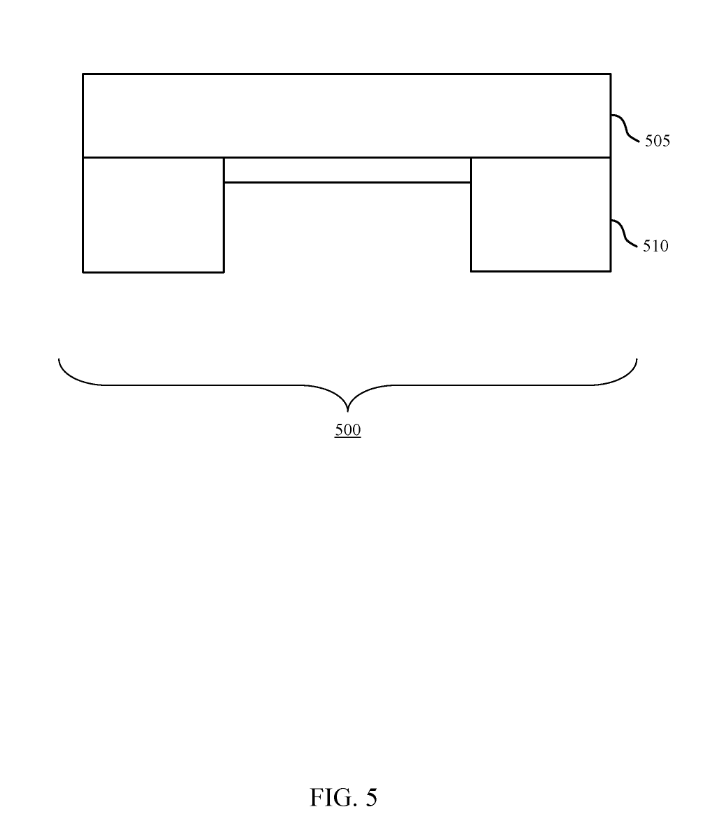

Sign clip 200 may include front piece 205, side pieces 210, hook pieces 215, bumpers 220, and clip pieces 225. In some examples, front piece 205 may include a front rectangular plane and a front depth, wherein the front rectangular plane comprises a front height and a front width. Front piece 205 may be an example of, or include aspects of, the corresponding element described with reference to FIGS. 3 and 5.

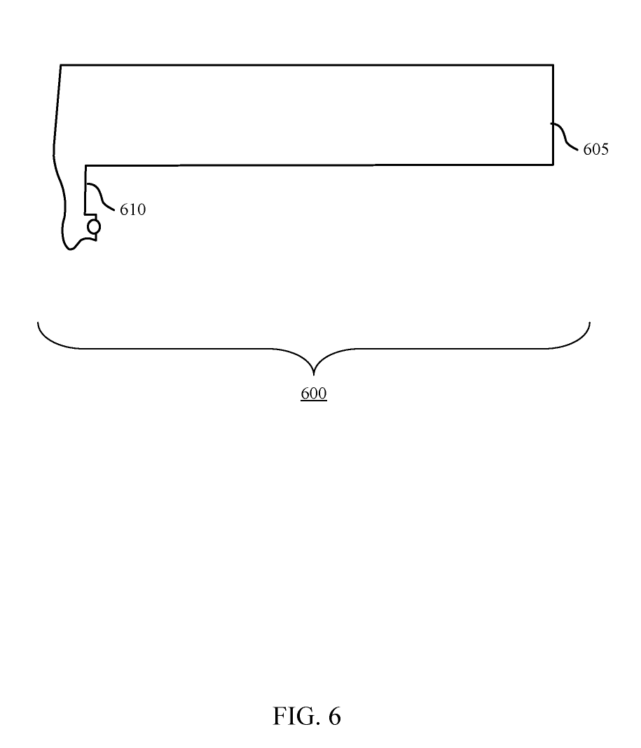

In some examples, two side pieces 210 may be connected to the front piece 205, wherein the two side pieces 210 are connected to the front piece 205 on two sides of the front piece 205 separated by the front width, wherein each of the two side pieces 210 comprises a side rectangular plane and a side depth, wherein each side rectangular plane comprises a side height equal to the front height and a side width, and wherein each side rectangular plane is perpendicular to the front rectangular plane so that the front piece 205 and the two side pieces 210 form a portion of a square with at least one open side. Side pieces 210 may be an example of, or include aspects of, the corresponding element described with reference to FIGS. 3 and 6.

In some examples, sign clip 200 may include one or more hook pieces 215, wherein each of the hook pieces 215 is connected to one of the two side pieces 210 on an opposite side of the connected side piece 210 from the front piece 205, wherein each of the one or more hook pieces 215 comprises a hook rectangular plane and a hook depth, and wherein each hook rectangular plane is perpendicular to each side rectangular plan and parallel to the front rectangular plane such that each of the one or more hook pieces 215 is arranged along the open side of the square. Hook pieces 215 may be an example of, or include aspects of, the corresponding element described with reference to FIG. 3.

In some examples, bumpers 220 are located on an interior side of the front piece 205 or one of the two side pieces 210, wherein the interior side comprises a side of the front piece 205 or one of the two side pieces 210 on the interior of the open square. In some examples, the one or more bumpers 220 comprise rubber bumpers 220, elastomer bumpers 220, or any combination thereof and the one or more bumpers 220 comprise a circular shape or any combination thereof. Bumpers 220 may be an example of, or include aspects of, the corresponding element described with reference to FIG. 3.

FIG. 3 shows an example of a top view of a sign clip 300 in accordance with aspects of the present disclosure. The example shown includes sign clip 300, which may be an example of, or include aspects of, the corresponding element described with reference to FIGS. 1, 2, 4, 5, and 6.

In some examples, the front piece 305, the two side pieces 310, and the one or more hook pieces 315 comprise a rigid material and the bumpers 320 comprise a compressible material having a compressibility greater than the rigid material; the front piece 305, the two side pieces 310, and the one or more hook pieces 315 comprise a plastic, wood, metal, or any combination thereof; and the front piece 305, the two side pieces 310, the one or more hook pieces 315, and the clip pieces 325 comprise a seamless structure from a single material or any combination thereof.

Sign clip 300 may include front piece 305, side pieces 310, hook pieces 315, bumpers 320, and clip piece 325. In some examples, front piece 305 may include a front rectangular plane and a front depth, wherein the front rectangular plane comprises a front height and a front width. Front piece 305 may be an example of, or include aspects of, the corresponding element described with reference to FIGS. 2, 4 and 5.

In some examples, two side pieces 310 are connected to the front piece 305, wherein the two side pieces 310 are connected to the front piece 305 on two sides of the front piece 305 separated by the front width, wherein each of the two side pieces 310 comprises a side rectangular plane and a side depth, wherein each side rectangular plane comprises a side height equal to the front height and a side width, and wherein each side rectangular plane is perpendicular to the front rectangular plane so that the front piece 305 and the two side pieces 310 form a portion of a square with at least one open side. Side pieces 310 may be an example of, or include aspects of, the corresponding element described with reference to FIGS. 2, 4 and 6.

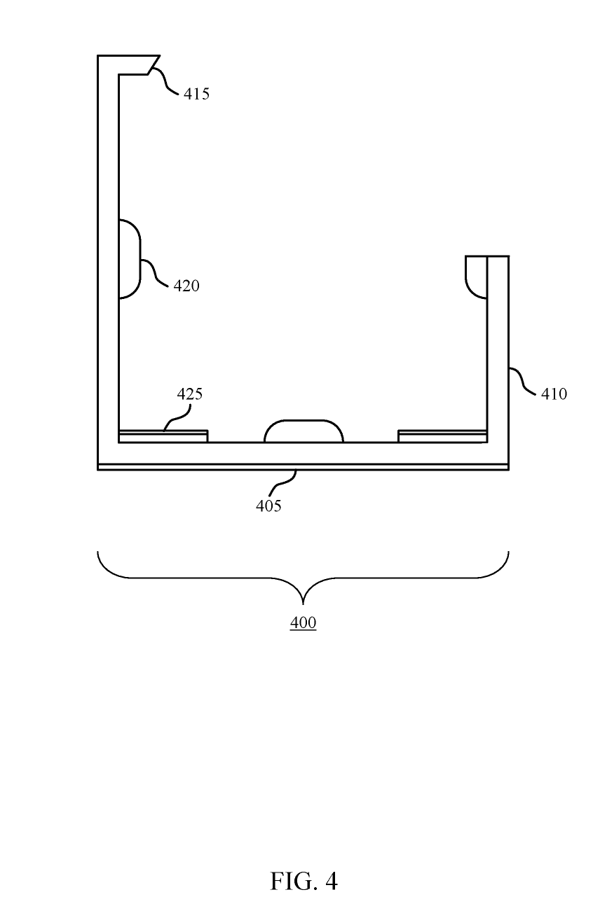

In some examples, one or more hook pieces 315 are connected to the two side pieces 310 on an opposite side of the connected side piece 310 from the front piece 305, wherein each of the one or more hook pieces 315 comprises a hook rectangular plane and a hook depth, and wherein each hook rectangular plane is perpendicular to each side rectangular plan and parallel to the front rectangular plane such that each of the one or more hook pieces 315 is arranged along the open side of the square. Hook pieces 315 may be an example of, or include aspects of, the corresponding element described with reference to FIGS. 2 and 4.

In some examples, bumpers 320 may be located on an interior side of the front piece 305 or one of the two side pieces 310, wherein the interior side comprises a side of the front piece 305 or one of the two side pieces 310 on the interior of the open square. In some examples, the one or more bumpers 320 comprise rubber bumpers 320, elastomer bumpers 320, or any combination thereof and the one or more bumpers 320 comprise a circular shape or any combination thereof. Bumpers 320 may be an example of, or include aspects of, the corresponding element described with reference to FIGS. 2 and 4.

In some examples, clip pieces 325 may be connected to the front piece 305. In some examples, the one or more clip pieces 325 extend a first length in the direction of the front rectangular plane and a second length in the direction of the front depth toward the interior of the square and each of the one or more clip pieces 325 comprise a spring component or any combination thereof. Clip pieces 325 may be an example of, or include aspects of, the corresponding element described with reference to FIGS. 5 and 6.

FIG. 4 shows an example of a top view of a sign clip 400 with a short side piece 410 in accordance with aspects of the present disclosure. The example shown includes sign clip 400, which may be an example of, or include aspects of, the corresponding element described with reference to FIGS. 1, 2, 3, 5, and 6.

The sign clip 400 may include front piece 405, short side piece 410, hook piece 415, bumpers 420, and clip piece 425. Description of components which are similar to those in FIGS. 1, 2, and 3 has been omitted.

The sign clip 400 may be similar in many respects to the sign clip 300 described with reference to FIG. 3. However, sign clip 400 may have a short side piece 410 on one side to ensure easier application of the sign clip 400 to a pole. Because the short side piece 410 may be shorter than the width of the pole, a hook piece 415 may only be located on one side (i.e., the side opposite the short side piece 410.

FIG. 5 shows an example of a front view of a sign clip 500 in accordance with aspects of the present disclosure. The example shown includes sign clip 500, which may be an example of, or include aspects of, the corresponding element described with reference to FIGS. 1, 2, 3, and 6.

In some examples, the front piece 505, the two side pieces, and the one or more hook pieces comprise a rigid material and the bumpers comprise a compressible material having a compressibility greater than the rigid material; the front piece 505, the two side pieces, and the one or more hook pieces comprise a plastic, wood, metal, or any combination thereof; and the front piece 505, the two side pieces, the one or more hook pieces, and the clip pieces 510 comprise a seamless structure from a single material or any combination thereof.

Sign clip 500 may include front piece 505 and clip piece 510. In some examples, front piece 505 may include a front rectangular plane and a front depth, wherein the front rectangular plane comprises a front height and a front width. Front piece 505 may be an example of, or include aspects of, the corresponding element described with reference to FIGS. 2 and 3.

In some examples, clip pieces 510 may be connected to the front piece 505. In some examples, the one or more clip pieces 510 extend a first length in the direction of the front rectangular plane and a second length in the direction of the front depth toward the interior of the square and each of the one or more clip pieces 510 comprise a spring component or any combination thereof. Clip pieces 510 may be an example of, or include aspects of, the corresponding element described with reference to FIGS. 3 and 6.

FIG. 6 shows an example of a side view of a sign clip 600 in accordance with aspects of the present disclosure. The example shown includes sign clip 600, which may be an example of, or include aspects of, the corresponding element described with reference to FIGS. 1, 2, 3, and 5.

In some examples, the front piece, the two side pieces 605, and the one or more hook pieces comprise a rigid material and the bumpers comprise a compressible material having a compressibility greater than the rigid material; the front piece, the two side pieces 605, and the one or more hook pieces comprise a plastic, wood, metal, or any combination thereof and the front piece, the two side pieces 605, the one or more hook pieces, and the clip pieces 610 comprise a seamless structure from a single material or any combination thereof.

Sign clip 600 may include side piece 605 and clip piece 610. In some examples, side piece 605 may be connected to a front piece, wherein the two side pieces 605 are connected to the front piece on two sides of the front piece separated by the front width, wherein each of the two side pieces 605 comprises a side rectangular plane and a side depth, wherein each side rectangular plane comprises a side height equal to the front height and a side width, and wherein each side rectangular plane is perpendicular to the front rectangular plane so that the front piece and the two side pieces 605 form a portion of a square with at least one open side. Side piece 605 may be an example of, or include aspects of, the corresponding element described with reference to FIGS. 2 and 3.

In some examples, clip piece 610 may be connected to the front piece. In some examples, the one or more clip pieces 610 extend a first length in the direction of the front rectangular plane and a second length in the direction of the front depth toward the interior of the square and each of the one or more clip pieces 610 comprise a spring component or any combination thereof. Clip piece 610 may be an example of, or include aspects of, the corresponding element described with reference to FIGS. 3 and 5.

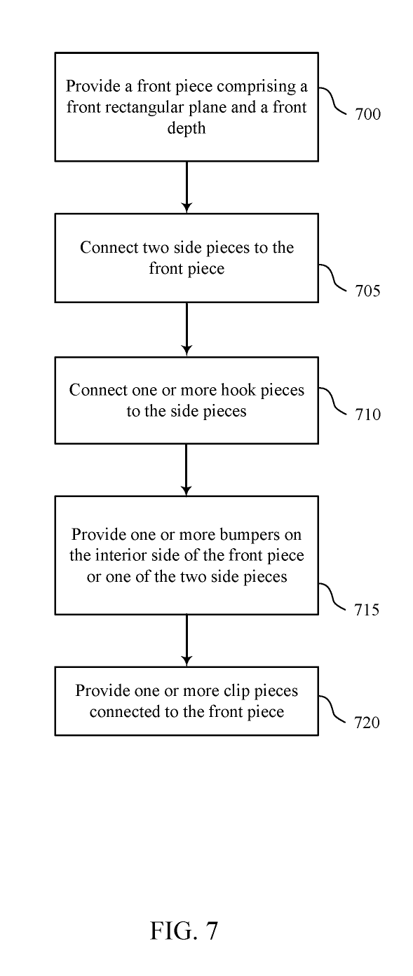

FIG. 7 shows an example of manufacturing a sign clip in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 705, a system may provide a front piece comprising a front rectangular plane and a front depth, where the front rectangular plane comprises a front height and a front width.

At step 710, a system may connect two side pieces to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side.

At step 715, a system may connect one or more hook pieces to a side piece on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square.

At step 720, a system may provide one or more bumpers located on an interior side of the front piece or one of the two side pieces, wherein the interior side comprises a side of the front piece or one of the two side pieces on the interior of the open square.

At step 725, a system may provide one or more clip pieces connected to the front piece.

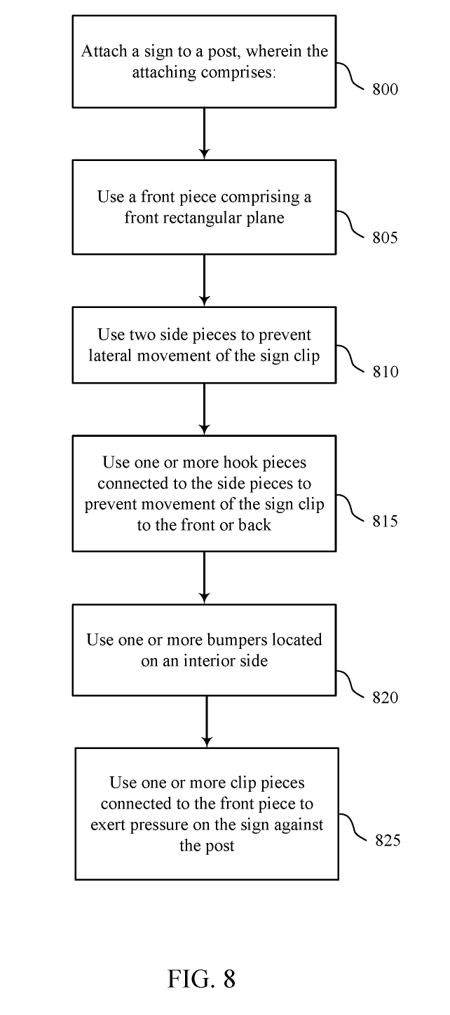

FIG. 8 shows an example of attaching a sign to a post in accordance with aspects of the present disclosure.

At step 805, a user may attach a sign to a post using a sign clip, wherein the attaching comprises the steps below.

At step 810, a user may use a front piece to prevent backward movement of the sign clip, the front piece comprising a front rectangular plane and a front depth, where the front rectangular plane comprises a front height and a front width.

At step 815, a user may use two side pieces to prevent lateral movement of the sign clip, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side.

At step 820, a user may use one or more hook pieces connected to the side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square.

At step 825, a user may use one or more bumpers located on an interior side of the front piece or one of the two side pieces, wherein the interior side comprises a side of the front piece or one of the two side pieces on the interior of the open square.

At step 830, a user may use one or more clip pieces connected to the front piece to exert pressure on the sign against the post.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. An apparatus for attaching a sign to a post, comprising:
a front piece comprising a front rectangular plane and a front depth, wherein the front rectangular plane comprises a front height and a front width;
two side pieces connected to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side;
one or more hook pieces, wherein each of the hook pieces is connected to one of the two side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square;
one or more bumpers located on an interior side of the front piece or one of the two side pieces, wherein the interior side comprises a side of the front piece or one of the two side pieces on the interior of the open square; and
one or more clip pieces connected to the front piece.

2. The apparatus of claim 1, wherein:
the front piece, the two side pieces, and the one or more hook pieces comprise a rigid material and the bumpers comprise a compressible material having a compressibility greater than the rigid material.

3. The apparatus of claim 2, wherein:
the front piece, the two side pieces, and the one or more hook pieces comprise a plastic, wood, metal, or any combination thereof.

4. The apparatus of claim 2, wherein:
the one or more bumpers comprise rubber bumpers, elastomer bumpers, or any combination thereof.

5. The apparatus of claim 1, wherein:
the one or more bumpers comprise a circular shape.

6. The apparatus of claim 1, wherein:
the one or more clip pieces extend a first length in the direction of the front rectangular plane and a second length in the direction of the front depth toward the interior of the square.

7. The apparatus of claim 1, wherein:
each of the one or more clip pieces comprise a spring component.

8. The apparatus of claim 1, wherein:
the front piece, the two side pieces, the one or more hook pieces, and the clip pieces comprise a seamless structure from a single material.

9. A system for attaching a sign to a post, comprising:
a post and a sign clip; the sign clip further comprising:
a front piece comprising a front rectangular plane and a front depth, wherein the front rectangular plane comprises a front height and a front width;
two side pieces connected to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side;
one or more hook pieces, wherein each of the hook pieces is connected to one of the two side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square;
one or more bumpers located on an interior side of the front piece or one of the two side pieces, wherein the interior side comprises a side of the front piece or one of the two side pieces on the interior of the open square; and
one or more clip pieces connected to the front piece.

10. The system of claim 9, wherein:
the front piece, the two side pieces, and the one or more hook pieces comprise a rigid material and the bumpers comprise a compressible material having a compressibility greater than the rigid material.

11. The system of claim 10, wherein:
the one or more bumpers comprise rubber bumpers, elastomer bumpers, or any combination thereof.

12. The system of claim 9, wherein:
the one or more bumpers comprise a circular shape.

13. The system of claim 9, wherein:
the one or more clip pieces extend a first length in the direction of the front rectangular plane and a second length in the direction of the front depth toward the interior of the square.

14. The system of claim 9, wherein:
each of the one or more clip pieces comprise a spring component.

15. The system of claim 9, wherein:
the front piece, the two side pieces, the one or more hook pieces, and the clip pieces comprise a seamless structure from a single material.

16. A method of manufacturing an apparatus for attaching a sign to a post, the method comprising:
providing a front piece comprising a front rectangular plane and a front depth, wherein the front rectangular plane comprises a front height and a front width;
providing two side pieces connected to the front piece, wherein the two side pieces are connected to the front piece on two sides of the front piece separated by the front width, wherein each of the two side pieces comprises a side rectangular plane and a side depth, wherein each side rectangular plane comprises a side height equal to the front height and a side width, and wherein each side rectangular plane is perpendicular to the front rectangular plane so that the front piece and the two side pieces form a portion of a square with at least one open side;
providing one or more hook pieces, wherein each of the hook pieces is connected to one of the two side pieces on an opposite side of the connected side piece from the front piece, wherein each of the one or more hook pieces comprises a hook rectangular plane and a hook depth, and wherein each hook rectangular plane is perpendicular to each side rectangular plan and parallel to the front rectangular plane such that each of the one or more hook pieces is arranged along the open side of the square;
providing one or more bumpers located on an interior side of the front piece or one of the two side pieces, wherein the interior side comprises a side of the front piece or one of the two side pieces on the interior of the open square; and
providing one or more clip pieces connected to the front piece.

17. The method of claim 16, wherein:
the front piece, the two side pieces, and the one or more hook pieces comprise a rigid material and the bumpers comprise a compressible material having a compressibility greater than the rigid material.

18. The method of claim 17, wherein:
the front piece, the two side pieces, and the one or more hook pieces comprise a plastic, wood, metal, or any combination thereof.

19. The method of claim 17, wherein:
the one or more bumpers comprise rubber bumpers, elastomer bumpers, or any combination thereof.

20. The method of claim 16, wherein:
the one or more bumpers comprise a circular shape.
